(19) United States
(12) Patent Application Publication
(10) Pub. No.: US 2023/0323040 A1
(43) Pub. Date: Oct. 12, 2023

(54) ELECTRIC FIELD INDUCED GRADED HYDROGEL FILMS

(71) Applicant: PALO ALTO RESEARCH CENTER INCORPORATED, PALO ALTO, CA (US)

(72) Inventors: ERIC PALERMO, FAYETTEVILLE, PA (US); RAVI NEELAKANTAN, SAN DIEGO, CA (US)

(21) Appl. No.: 17/717,472

(22) Filed: Apr. 11, 2022

(51) Int. Cl. C08J 3/075; C08J 5/18; C08J 3/24; C08K 5/00; C08K 5/20; C08K 5/17; C08J 3/28

(52) U.S. Cl. CPC C08J 3/075; C08J 5/18; C08J 3/24; C08K 5/0025; C08K 5/20; C08K 5/17; C08J 3/28; C08J 2331/00

(57) ABSTRACT

A crosslinked, co-polymer hydrogel film has a continuous spatial gradient of functional co-monomers across a dimension of the film. A method of manufacturing a hydrogel film includes preparing a solution of a hydrogel-forming polymer, a functional ionic co-monomer, a polymerization initiator, an accelerator, and a solvent, transferring the solution to a mold and arranging the mold between two electrodes, applying a voltage to the electrodes to cause the ionic co-monomer to migrate towards an oppositely charged one of the two electrodes, and applying a polymerization energy to the solution to fix a position of the co-monomers within a resulting polymer matrix.

### TECHNICAL FIELD

This disclosure relates to hydrogels, more particularly to applying electric fields to cause graded properties in hydrogels

### BACKGROUND

Hydrogels have received a lot of focus due to their biocompatibility and their reversibly changeable properties upon exposure to stimuli such as temperature, pH, and light. In addition, hydrogels with non-homogenous properties have attracted attention because of the anisotropic swelling behavior. This behavior enables directional deformation and makes non-homogenous hydrogels particularly useful for biomimetic actuator applications as they can mimic biochemical processes.

Graded hydrogels in particular promote the desired swelling characteristics. However, no processes exist for fabricating continuously graded, non-composite hydrogels from monomers in solution. Component incompatibilities with the polymer matrix, inherent to composite materials, limits graded hydrogels as a solution. Conventional methods to construct graded hydrogels involves layering of distinct materials. These layered composites can suffer from poor interfacial compatibility between layers. This leads to both structural weaknesses in the gel and poor mass transport between layers.

A more recent approach involving application of an electric field to a suspension of nanoparticles in a polymer solution has led to continuous material gradients produced by the migration of charged nanoparticles to one surface of the hydrogel. This solution solves issues with incompatibility between layers, but the use of heterogeneous nanoparticles leads to poor interfacial compatibility between the nanoparticles and the polymer matrix. No current solution exists for a process to produce a non-composite hydrogel with a continuous functional gradient using charged monomer ions in solution.

### SUMMARY

According to aspects illustrated here, there is provided a crosslinked, co-polymer hydrogel film having a continuous spatial gradient of functional co-monomers across a dimension of the film.

According to aspects illustrated here, there is provided a method of manufacturing a hydrogel film includes preparing a solution of a hydrogel-forming polymer, a functional ionic co-monomer, a polymerization initiator, an accelerator, and a solvent, transferring the solution to a mold and arranging the mold between two electrodes, applying a voltage to the electrodes to cause the ionic co-monomer to migrate towards an oppositely charged one of the two electrodes, and applying a polymerization energy to the solution to fix a position of the co-monomers within a resulting polymer matrix.

### BRIEF DESCRIPTION OF THE DRAWINGS

FIG. 1 shows a flowchart of an embodiment of manufacturing a hydrogel having a continuous gradient.

FIG. 2 shows an embodiment of a hydrogel having a continuous gradient in a one-dimensional dimension.

FIG. 3 shows an embodiment of an apparatus for forming a hydrogel having a continuous gradient.

FIG. 4 shows an alternative embodiment of an apparatus for forming a hydrogel having a continuous gradient.

### DETAILED DESCRIPTION OF THE EMBODIMENTS

The embodiments here involve a process of using an electric field to produce a non-composite hydrogel with an intrinsic gradient in monomeric unit concentration. The embodiments include a gradient in functionality in one dimension of the hydrogel.

As used here, the term “ionic co-monomer” means a monomer that contains positively and negatively charged ions in solution. The ionic co-monomer exists in solution as a charged ion balanced by a counter-ion. The counter-ion does not take part in the polymerization process, resulting in the monomer having a net charge balanced by a separately charged species. The term “functional group” refers to the charged ions within the co-monomer.

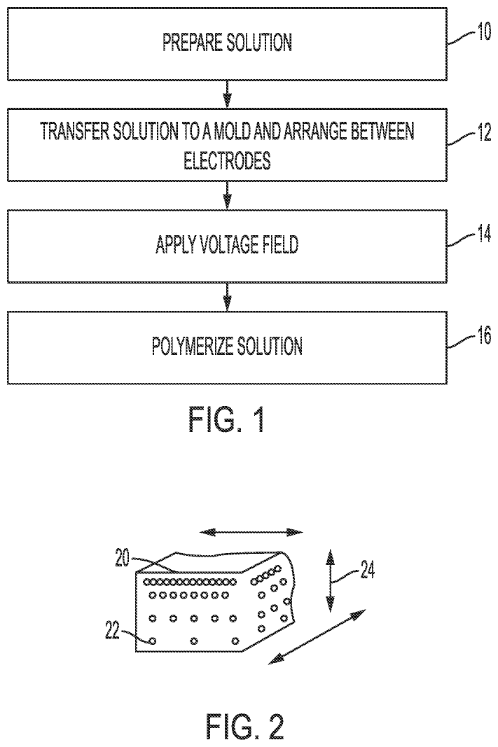

FIG. 1 shows a flowchart of an embodiment of a method of manufacturing a hydrogel film. The process begins by preparing a solution of a hydrogel-forming polymer, a functional ionic co-monomer, a polymerization initiator in water, where water is the solvent, at 10. The solution may include a crosslinker and an accelerant. Once mixed, the solution is transferred to a mold and the mold is arranged between two electrodes connected to an external voltage source at 12. Application of the voltage at 14 to the electrodes causes the ionic co-monomer to migrate towards the oppositely charged electrode. The initiation of the polymerization reaction fixes the position of the ionic co-polymers within the polymer matrix. In one example using UV-curable polymers, the polymerization reaction initiates upon exposure to UV light. In an embodiment using UV-curable polymers, the polymerization reaction initiates upon exposure to UV light.

Preparing the solution of hydrogel-forming polymer may comprise using one of either polyethylene glycol diacrylate or N-isopropyl acrylamide, among others. The discussion here may also refer to the hydrogel-forming polymer as being hydrophilic. Further, the ionic co-monomer may comprise one of either [2-(acryloyloxy)ethyl]trimethylammonium chloride, among others. There is no limitation to the ionic co-monomer. In order for the ionic co-monomer to react to the electric field applied, it should be charged at the pH of the solution. The ionic co-monomer may be selected based upon the function of the desired gradient, such as wettability, unique optical properties that vary the optical properties, or ionic co-monomer that have an affinity towards certain pharmaceuticals or biomolecules, which provide a gradient in diffusion rate. Another type of gradient could be in lower critical solution temperature (LCST), which affects the miscibility of the hydrogel.

In one embodiment, the hydrophilic polymer may be present in an amount ranging from 3-13 wt % with respect to the solvent. In another embodiment the ionic co-monomer may present in an amount ranging from 1-4 wt % with respect to the hydrophilic polymer/

In one embodiment preparing the solution may further comprise adding a crosslinker to the solution. In one embodiment, the crosslinker may comprise N,N′-methyenebisacrylamide. In one embodiment the crosslinker may be present an amount ranging from 1-4 wt % with respect to the hydrogel-forming polymer.

In one embodiment, the photoinitiator comprises one of potassium persulfate or 2,2-dimethoxy-2-phenylacetophenone in 1-vinyl-2-pyrrolidinone. In one embodiment, the photoinitiator may be present in an amount ranging from 0.8-5.0 wt % with respect to the hydrogel-forming polymer. In one embodiment, the photoinitiator comprises 2,2-dimethoxy-2-phenylacetophenone in 1-vinyl-2-pyrrolidinone in an amount ranging from 25-50 μL per mL of solvent.

In one embodiment, the solution may include an accelerator. In one embodiment, the accelerator may comprise N,N,N′,N′-Tetramethylethylenediamine. In one embodiment, the accelerator may be present in the solution in an amount ranging from 1-10 μL per mL of solvent.

In one embodiment, applying the voltage comprises applying an electric field having a potential difference in the range of 1 to 40 V across the polymer solution. In one embodiment the electric field is applied for approximately 2 to 30 minutes.

In one embodiment, application of a polymerization energy comprises exposing the mold and the fixture to a longwave UV light source. As used here, the term “longwave” means the lowest frequency ultraviolet light having wavelengths between 320 and 400 nm.

When arranging the mold, between the electrodes, the process could arrange the mold such that the gradient of the ionic co-monomer forms across one dimension of the resulting hydrogel. If the mold has dimensions that differ, such as the length and width of a rectangle, the arrangement of the mold determines in which dimension the gradient forms. No restriction of the shape of the mold is intended, nor should any be implied. The shape of the mold may be cylindrical, spherical, cubed, rectangular, hexagonal, etc.

The resulting crosslinked co-polymer hydrogel film has an intrinsic, continuous gradient in a spatial concentration of functional co-monomers across a dimension of the film. As used here, the term “intrinsic” means non-composite, meaning that it is part of the hydrogel, as opposed to those gradients that are created by layering of distinct materials. The term “functional” means that the ionic co-monomer creates or changes a characteristic or property of the hydrogel, such as wettability, refractive index, etc. The gradient of the ionic co-monomer provides a functional gradient across the dimension of the film. The choice of the ionic co-monomer allows for different properties of the gradient. These may include, but are not limited to, a wettability gradient, a refractive index gradient, or a lower critical solution temperature gradient (LCST).

FIG. 2 shows a graphical representation of a hydrogel having a gradient in one dimension. In the embodiment shown, a portion of a hydrogel is shown in which a gradient exists regarding the monomers such as 22. When the electric field is applied, the charged monomers will move towards the oppositely charged electrode, thereby forming the gradient. This becomes fixed into place when polymerization occurs. In this particular illustration, the gradient occurs across the dimension of the hydrogel corresponding to arrow 24. The gradient could instead form in the dimensions represented by the other arrows, depending upon the orientation of the mold place between the electrodes of the apparatus.

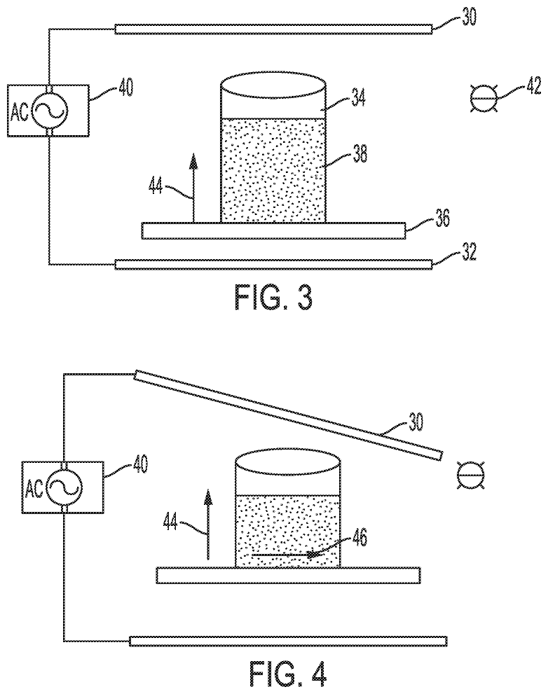

FIG. 3 shows an embodiment of an apparatus for the creation of a hydrogel having an intrinsic, continuous functional gradient across its mass in one dimension. The apparatus comprises two electrodes 30 and 32, connected to a voltage source 40. In one embodiment, the electrodes may comprise indium tin oxide (ITO) on glass. The mold 34 may be placed on a fixture such as 36 or directly on the lower electrode 32. As the electrical field begins to act on the hydrogel, the ionic co-monomer begins to migrate towards the oppositely charged electrode forming a gradient. In this example, the gradient varies in the direction of the arrow 44 shown, having a higher concentration of the ionic co-monomers at one or the other electrode depending upon the charge of the co-monomer.

In FIG. 4, the apparatus could be adapted to cause a gradient within the gradient to form. By angling one of the electrodes such as 30 to be closer to the other electrode, the ionic co-monomer will form a gradient in the direction of the first arrow 44, but within that gradient, another gradient forms in the direction of the arrow 46 due to the variation of the electric field strength (V/m) along that direction.

Once the gradient has formed, the process then fixes the gradient into place by polymerizing the monomers. In the apparatus shown in FIG. 3, the polymerization results from exposing the solution with a photoinitiator to a light source 42. In one embodiment, the light source provides longwave UV light.

In this manner, a hydrogel can have controlled, graded properties. Gradients may allow the hydrogel to have gradients in wettability, refractive index, LCST, or reactivity to different pharmaceuticals, biomolecules, or other materials.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A crosslinked co-polymer hydrogel film having a continuous spatial gradient of functional co-monomers across a dimension of the film.

2. The hydrogel film as claimed in claim 1, wherein the continuous gradient comprises a wettability gradient.

3. The hydrogel film as claimed in claim 1, wherein the continuous gradient comprises a refractive index gradient.

4. The hydrogel film as claimed in claim 1, wherein the continuous gradient is a lower critical solution temperature gradient.

5. The method as claimed in claim 1, wherein the ionic co-polymer is hydrophilic.

6. The method as claimed in claim 1, wherein the ionic co-polymer is charged at a pH of the solution.

7. A method of manufacturing a hydrogel film, comprising:
preparing a solution of a hydrogel-forming polymer, a functional ionic co-monomer, a polymerization initiator, an accelerator, and a solvent;
transferring the solution to a mold and arranging the mold between two electrodes;
applying a voltage to the electrodes to cause the ionic co-monomer to migrate towards an oppositely charged one of the two electrodes; and
applying a polymerization energy to the solution to fix a position of the co-monomers within a resulting polymer matrix.

8. The method as claimed in claim 7, wherein preparing the solution further comprises adding a crosslinker to the solution.

9. The method as claimed in claim 8, wherein the crosslinker comprises N,N′-Methyenebisacrylamide.

10. The method as claimed in claim 7, wherein accelerator comprises N,N,N′,N′-Tetramethylethylenediamine

11. The method as claimed in claim 7, wherein the hydrogel-forming polymer comprises one of polyethylene glycol diacrylate and N-isopropyl acrylamide.

12. The method as claimed in claim 7, wherein the ionic co-monomer comprises [2-(acryloyloxy)ethyl]trimethylammonium chloride.

13. The method as claimed in claim 7, wherein the solution comprises:
hydrophilic polymer is N-isopropylacrylamide present in an amount ranging from 3-13 wt % with respect to the solvent;
the ionic co-monomer is [2-(acryloyloxy)ethyl]trimethylammonium chloride present in an amount ranging from 1-4 wt % with respect to the hydrophilic polymer;
a crosslinker of N,N′-Methylenebisacrylamide present in an amount ranging from 1-4 wt % with respect to the hydrogel-forming polymer;
the photoinitiator is potassium persulfate present in an amount ranging from 0.8-5.0 wt % with respect to the hydrogel-forming polymer; and
an accelerator is N,N,N′,N′-Tetramethylethylenediamine present in an amount ranging from 1-10 μL per mL of solvent.

14. The method as claimed in claim 7, wherein the solution comprises:
the hydrogel-forming polymer is polyethylene glycol diacrylate present in an amount ranging from 10-50 wt % with respect to the solvent;
the ionic co-monomer is [2-(acryloyloxy)ethyl]trimethylammonium chloride present in an amount ranging from 50-800 wt % with respect to the hydrophilic polymer; and
the photoinitiator is a 300 mg/mL solution of 2,2-dimethoxy-2-phenylacetophenone in 1-vinyl-2-pyrrolidinone present in an amount ranging from 25-50 μL per mL of solvent.

15. The method as claimed in claim 7, wherein applying a voltage to the electrodes comprises applying an electric field with a potential difference in the range of 1 to 40 V across the polymer solution.

16. The method as claimed in claim 7, wherein applying a polymerization energy comprises exposing the mold and fixture to a longwave UV light source.
